(19) United States
(12) Patent Application Publication
(10) Pub. No.: US 2017/0177963 A1
(43) Pub. Date: Jun. 22, 2017

(54) ARTICLES CAPABLE OF USE IN ALPR SYSTEMS

(71) Applicant: 3M INNOVATIVE PROPERTIES COMPANY, St. Paul, MN (US)

(72) Inventors: Lee A. Pavelka, Cottage Grove, MN (US); Neeraj Sharma, Woodbury, MN (US); Thomas J. Dahlin, Ironwood, MI (US); Michael R. Duoos, Lino Lakes, MN (US)

(21) Appl. No.: 15/128,396

(22) PCT Filed: Mar. 24, 2015
(86) PCT No.: PCT/US2015/022108

§ 371 Date: Sep. 22, 2016

Related U.S. Application Data
(60) Provisional application No. 61/969,889, filed on Mar. 25, 2014.

(51) Int. Cl. G06K 9/20; G02B 5/26; G02B 5/12; G02B 5/20; G06K 9/32; B60R 13/10

(52) U.S. Cl. CPC G06K 9/2018; G06K 9/3258; B60R 13/10; G02B 5/12; G02B 5/208; G02B 5/26; G06K 2209/15

(57) ABSTRACT

The present disclosure relates to optically active sheeting and/or license plates, methods of making and using these; and systems in which these can be used.

### TECHNICAL FIELD

The present disclosure relates to optically active sheeting and/or license plates, methods of making and using these; and systems in which these can be used.

### BACKGROUND

Automatic Vehicle Recognition (AVR) is a term applied to the detection and recognition of a vehicle by an electronic system. Exemplary uses for AVR include, for example, automatic tolling (e.g., electronic toll systems), traffic law enforcement (e.g., red radiation running systems, speed enforcement systems), searching for vehicles associated with crimes, access control systems, and facility access control. Ideal AVR systems are universal (i.e., they are able to identify a vehicle with 100% accuracy). The two main types of AVR systems in use today are (1) systems using RFID technology to read an RFID tag attached to a vehicle and (2) systems using a machine or device to read a machine-readable code attached to a vehicle.

One advantage of RFID systems is their high accuracy, which is achieved by virtue of error detection and correction information contained on the RFID tag. Using well known mathematical techniques (cyclic redundancy check, or CRC, for example), the probability that a read is accurate (or the inverse) can be determined. However, RFID systems have some disadvantages, including that not all vehicles include RFID tags. Also, existing unpowered “passive” RFID tag readers may have difficulty pinpointing the exact location of an object. Rather, they simply report the presence or absence of a tag in their field of sensitivity. Moreover, many RFID tag readers only operate at short range, function poorly in the presence of metal, and are blocked by interference when many tagged objects are present. Some of these problems can be overcome by using active RFID technology or similar methods. However, these techniques require expensive, power-consuming electronics and batteries, and they still may not determine position accurately when attached to dense or metallic objects.

Machine vision systems (often called Automated License Plate Readers or ALPR systems) use a machine or device to read a machine-readable code attached to a vehicle. In many embodiments, the machine readable code is attached to, printed on, or adjacent to a license plate. ALPR systems rely on an accurate reading of a vehicle's license plate. License plates can be challenging for an ALPR system to read due to at least some of the following factors: (1) varying reflective properties of the license plate materials; (2) non-standard fonts, characters, and designs on the license plates; (3) varying embedded security technologies in the license plates; (4) variations in the cameras or optical character recognition systems; (5) the speed of the vehicle passing the camera or optical character recognition system; (6) the volume of vehicles flowing past the cameras or optical character recognition systems; (7) the spacing of vehicles flowing past the cameras or optical character recognition systems; (8) wide variances in ambient illumination surrounding the license plates; (9) weather; (10) license plate mounting location and/or tilt; (11) wide variances in license plate graphics; (12) the detector-to-license plate-distance permissible for each automated enforcement system; and (13) occlusion of the license plate by, for example, other vehicles, dirt on the license plate, articles on the roadway, natural barriers, etc.

One advantage of ALPR systems is that they are can be used almost universally, since almost all areas of the world require that vehicles have license plates with visually identifiable (also referred to as human-readable) information thereon. However, the task of recognizing visual information can be complicated. For example, the read accuracy from an ALPR system is largely dependent on the quality of the captured image as assessed by the reader. Existing systems have difficulty distinguishing human-readable information from complex backgrounds and handling variable radiationing. Further, the accuracy of ALPR systems suffers when license plates are obscured or dirty.

Because recognition of visible information on license plates can be challenging for the reasons described above, some ALPR systems include machine-readable information (e.g. a bar code) containing or relating to information about the vehicle in addition to the human-readable information. In some instances, the bar code on a license plate includes inventory control information (i.e., a small bar code not intended to be read by the ALPR). Some publications (e.g., European Patent Publication No. 0416742 and U.S. Pat. No. 6,832,728) discuss including one or more of owner information, serial numbers, vehicle type, vehicle weight, plate number, state, plate type, and county on a machine-readable portion of a license plate. PCT Patent Publication No. WO 2013-149142 describes a license plate with a bar code wherein framing and variable information are obtained under two different conditions. In some embodiments, the framing information is provided by human-readable information, and variable information is provided by machine-readable information. European Patent Publication No. 0416742, U.S. Pat. No. 6,832,728, and PCT Patent Publication No. WO 2013-149142 are all incorporated in their entirety herein.

Some prior art methods of creating high contrast license plates for use in ALPR systems involve including materials that absorb in the infra-red wavelength range and transmit in the visible wavelength range. For example, U.S. Pat. No. 6,832,728 (the entirety of which is hereby incorporated herein) describes license plates including visible transmissive, infra-red opaque indicia. U.S. Pat. No. 7,387,393 describes license plates including infra-red blocking materials that create contrast on the license plate. U.S. Pat. No. 3,758,193 describes infra-red transmissive, visible absorptive materials for use on retroreflective sheeting. The entirety of U.S. Pat. Nos. 6,832,728 and 3,758,193 and U.S. Pat. No. 7,387,393 are hereby incorporated herein.

Another prior art method of creating high contrast license plates for use in ALPR systems is described in U.S. Patent Publication No. 2010-0151213 and involves positioning an infrared-reflecting material adjacent to an optically active (e.g., reflective or retroreflective) substrate such that the infrared-reflecting material forms a pattern that can be read by an infrared sensor when the optically active substrate is illuminated by an infrared radiation source. The entirety of U.S. Patent Publication No. 2010-0151213 is incorporated herein by reference.

Another prior art method of creating high contrast license plates for use in ALPR systems involves inclusion of a radiation scattering material on at least a portion of retroreflective sheeting. As is described in U.S. Patent Publication No. 2012/0195470 (the entirety of which is hereby incorporated herein), the radiation scattering material reduces the brightness of the retroreflective sheeting without substantially changing the appearance of the retroreflective sheeting when viewed under scattered radiation, thereby creating a high contrast, wavelength independent, retroreflective sheeting that can be used in a license plate.

### SUMMARY

Many license plates include two types of license plate identifying information (referred to generally as first and second sets or types of identifying information). In some instances one set (also referred to as first set) of identifying information is human-readable (e.g. alphanumeric plate identification information) and the other set (also referred to as additional or second set) of identifying information is machine-readable (e.g., a bar code). In some instances, the first and second sets or types of identifying information occupy at least some of the same area on the license plate. In some instances, the first and second sets of identifying information physically overlap.

Many ALPR cameras detect or read the alphanumeric identifying information on the license plate by irradiating the license plate with radiation having a wavelength in the near infra-red (“IR”) range (e.g. at or above 750 nm, and in some instances at 810 nm). Many ALPR cameras detect or read the machine-readable identifying information by irradiating the license plate with radiation having a wavelength of greater than 910 nm (e.g. in some instances at 950 nm).

In many instances, the human-readable information on a license plate is printed using carbon black-containing inks which absorb radiation at all wavelengths. The inventors of the present disclosure recognized that because carbon black inks are detectable when exposed to radiation having a wavelength of 950 nm or greater, the machine readable information (e.g., second set of identifying information) on the license plate was challenging if not impossible to clearly read because it was obscured by the overlapping human-readable (e.g., first set of identifying) information which was also detectable when exposed to radiation having a wavelength of 910 nm or above.

In many instances, the human-readable information on a license plate is printed using cyan magenta yellow inks (“CMY inks”), which are not visible when viewed under near IR wavelengths. The inventors of the present disclosure realized that CMY inks are invisible at around 810 nm, which is the wavelength of radiation at which most existing ALPR cameras read human-readable information.

The inventors of the present disclosure sought to make license plate identification easier and/or to improve the accuracy of license plate indicia identification. The inventors of the present disclosure also recognized that a license plate or optically active sheeting with one set of identifying information (e.g. human-readable information) that is detectable when exposed to radiation having a wavelength of around 810 nm and that is non-interfering when exposed to radiation having a wavelength of about 910 nm or greater would be beneficial because many existing infra-red (“IR”) ALPR cameras read the human-readable information on a license plate using radiation having a wavelength of about 810 nm and read the machine-readable information on a license plate using radiation having a wavelength of about 950 nm. Having one set of identifying information (e.g., human-readable information) detectable when exposed to radiation having a wavelength of around 810 nm and undetectable when exposed to radiation having a wavelength of around 950 nm ensures that each of the sets of identifying information will be substantially visible or detectable despite their overlapping physical location.

The inventors recognized that one exemplary solution to these issues was to form optically active (e.g., reflective or retroreflective) sheeting or a license plate including one set of identifying information (in some instances, human-readable information like, for example, an alphanumeric identifier) that is (1) substantially visible when exposed to radiation having a wavelengths of 390-750 nm and (2) detectable when exposed to radiation having a wavelength of between about 750 nm and less than about 910 nm and (3) non-interfering when exposed to radiation having a wavelength of greater than about 910 nm.

In some embodiments, the license plate or optically active sheeting an additional set of identifying information (n some instances, machine-readable information like, for example, a bar code) that is (1) substantially invisible when exposed to radiation having a wavelength of between about 390 nm and about 700 nm; (2) non-interfering when exposed to radiation having a wavelength of between about 750 nm and about 850 nm; and (3) detectable when exposed to radiation having a wavelength of greater than 910 nm.

The inventors of the present disclosure discovered various materials capable of printing human-readable information license plate sheeting, withstanding the harsh outdoor conditions to which license plates are exposed, being capable of high tension and torque processing (e.g., embossing of alphanumerics on the license plate), while simultaneously having the optical properties described above (e.g., being visible when exposed to radiation having a wavelength of less than about 950 nm and being invisible when exposed to radiation having a wavelength of about 950 nm or greater).

Some embodiments relate to a license plate including identifying information that is (1) substantially visible when exposed to radiation having a wavelength that is between about 390 nm and about 700 nm; (2) detectable when exposed to radiation having a wavelength of between about 750 nm and about 850 nm; and (3) non-interfering when exposed to radiation having a wavelength of greater than 910 nm.

In some embodiments, the identifying information is (1) substantially visible when exposed to radiation having a wavelength of between about 450 nm and about 700 nm; (2) detectable when exposed to radiation having a wavelength of between about 790 nm and about 820 nm; and (3) non-interfering when exposed to radiation having a wavelength of about 930 nm to about 970 nm.

In some embodiments, the license plate also includes additional identifying information that is (1) substantially invisible when exposed to radiation having a wavelength of between about 390 nm and about 700 nm; (2) non-interfering when exposed to radiation having a wavelength of between about 750 nm and about 850 nm; and (3) detectable when exposed to radiation having a wavelength of greater than 910 nm.

In some embodiments, the additional identifying information is (1) substantially invisible when exposed to radiation having a wavelength of between about 450 nm and about 700 nm; (2) non-interfering when exposed to radiation having a wavelength of between about 790 nm and about 820 nm; and (3) detectable when exposed to radiation having a wavelength of between about 930 nm and about 970 nm.

In some embodiments, at least a portion of the license plate is reflective or retroreflective. In some embodiments, the identifying information includes at least one of alphanumerics, graphics, symbols, and/or the additional identifying information includes at least one of a bar code, alphanumerics, graphics, and symbols. In some embodiments, the identifying information includes at least one of an ink, a dye, a thermal transfer ribbon, a colorant, a pigment, and a transfer film. In some embodiments, the additional identifying information includes at least one of multi-layer optical film, a material including an optically active pigment or dye, or an optically active pigment or dye. In some embodiments, the identifying information is human-readable. In some embodiments, the additional identifying information is machine-readable. In some embodiments, the identifying information is (1) detectable when exposed to radiation having a wavelength of between about 750 nm and about 850 nm when viewed at an incidence angle of about 60 degrees or less and (2) non-interfering when exposed to radiation having a wavelength of greater than 910 nm when viewed at an incidence angle of about 60 degrees or less.

In some embodiments, the identifying information is (1) detectable when exposed to radiation having a wavelength of between about 750 nm and about 850 nm when viewed at an incidence angle of about 45 degrees or less and (2) non-interfering when exposed to radiation having a wavelength of greater than 910 nm when viewed at an incidence angle of about 45 degrees or less.

In some embodiments, the identifying information is (1) detectable when exposed to radiation having a wavelength of between about 750 nm and about 850 nm when viewed at an incidence angle of about 30 degrees or less and (2) non-interfering when exposed to radiation having a wavelength of greater than 910 nm when viewed at an incidence angle of about 30 degrees or less.

Some embodiments relate to retroreflective sheeting including (a) a first set of identifying information that is (1) visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less; and (b) a second set of identifying information that is (1) invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less.

In some embodiments, the first set of identifying information is (1) visible when exposed to radiation having a wavelength of between about 450 nm and about 700 nm at an incidence angle of 30 degrees or less; (2) detectable when exposed to radiation having a wavelength of between about 790 nm and about 820 nm at an incidence angle of 30 degrees or less; and (3) non-interfering when exposed to radiation having a wavelength of about 930 nm to about 970 nm an incidence angle of 30 degrees or less.

In some embodiments, the second set of identifying information is (1) invisible when exposed to radiation having a wavelength of between about 450 nm and about 700 nm at an incidence angle of 30 degrees or less; (2) undetectable when exposed to radiation having a wavelength of between about 790 nm and about 820 nm at an incidence angle of 30 degrees or less; and (3) detectable when exposed to radiation having a wavelength of between about 930 nm and about 970 nm at an incidence angle of 30 degrees or less.

In some embodiments, the first set of identifying information includes at least one of alphanumerics, graphics, symbols, and/or the second set of identifying information includes at least one of a bar code, alphanumerics, graphics, and symbols. In some embodiments, the first set of identifying information includes at least one of an ink, a dye, a thermal transfer ribbon, a colorant, a pigment, and a transfer film. In some embodiments, the additional identifying information includes at least one of multi-layer optical film, a material including an optically active pigment or dye, or an optically active pigment or dye. In some embodiments, the first set of identifying information is human-readable. In some embodiments, the second set of identifying information is machine-readable.

Some embodiments relate to a kit for making a license plate including (a) optically active sheeting; (b) identifying information on the optically active sheeting, the identifying information being (1) substantially invisible when exposed to radiation having a wavelength of between about 390 nm and about 700 nm at an incidence angle of 60 degrees or less; (2) undetectable when exposed to radiation having a wavelength of between about 750 nm and about 850 nm at an incidence angle of 60 degrees or less; and (3) detectable when exposed to radiation having a wavelength of greater than 910 nm at an incidence angle of 60 degrees or less; and (c) a material meant for application to the optically active sheeting that is (1) substantially visible when exposed to radiation having a wavelength of between about 390 nm and about 700 nm at an incidence angle of 60 degrees or less; (2) detectable when exposed to radiation having a wavelength of between about 750 nm and about 850 nm at an incidence angle of 60 degrees or less; and (3) non-interfering when exposed to radiation having a wavelength of greater than 910 nm at an incidence angle of 60 degrees or less.

In some embodiments, the kit further includes instructions for applying the material to the optically active sheeting.

Some embodiments relate to a kit for making a license plate including (a) optically active sheeting; (b) identifying information on the optically active sheeting, the identifying information being (1) substantially invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less; and (c) instructions for applying a material to the optically active sheeting, the material being (1) substantially visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less.

Some embodiments relate to a kit for making a license plate as described herein including (a) optically active sheeting; (b) identifying information on the optically active sheeting, the identifying information being (1) substantially invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less; and (c) a material meant for application to the optically active sheeting that is (1) substantially visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less.

Some kits further include an imaging system for printing or transferring the material onto the optically active sheeting.

Some embodiments relate to a method of making a license plate including (a) forming a first set of identifying information on optically active sheeting, the first set of identifying information formed by or including a first material that is (1) substantially visible when exposed to radiation having a wavelength that is between about 390 nm and about 700 nm; (2) detectable when exposed to radiation having a wavelength of between about 750 nm and about 850 nm; and (3) non-interfering when exposed to radiation having a wavelength of greater than 910 nm; and (b) forming a second set of identifying information on optically active sheeting, the second set of identifying information formed by or including a second material that is (1) substantially invisible when exposed to radiation having a wavelength of between about 390 nm and about 700 nm; (2) non-interfering when exposed to radiation having a wavelength of between about 750 nm and about 850 nm; and (3) detectable when exposed to radiation having a wavelength of greater than 910 nm.

In some embodiments, the first set of identifying information is (1) substantially visible when exposed to radiation having a wavelength of between about 450 nm and about 700 nm; (2) detectable when exposed to radiation having a wavelength of between about 790 nm and about 820 nm; and (3) non-interfering when exposed to radiation having a wavelength of about 930 nm to about 970 nm. In some embodiments, the second set of identifying information is (1) substantially invisible when exposed to radiation having a wavelength of between about 390 nm and about 700 nm; (2) non-interfering when exposed to radiation having a wavelength of between about 750 nm and about 850 nm; and (3) detectable when exposed to radiation having a wavelength of greater than 910 nm.

In some embodiments, at least a portion of the license plate is reflective or retroreflective. In some embodiments, the first set of identifying information includes at least one of alphanumerics, graphics, symbols, and/or the additional identifying information includes at least one of a bar code, alphanumerics, graphics, and symbols. In some embodiments, the first material is at least one of an ink, a dye, a thermal transfer ribbon, a colorant, a pigment, and a transfer film. In some embodiments, the second set of identifying information is formed from or includes at least one of multi-layer optical film, a material including an optically active pigment or dye, or an optically active pigment or dye. In some embodiments, the first set of identifying information is human-readable. In some embodiments, the second set of identifying information is machine-readable.

In some embodiments, the first set of identifying information is (1) detectable when exposed to radiation having a wavelength of between about 750 nm and about 850 nm when viewed at an incidence angle of about 60 degrees or less and (2) non-interfering when exposed to radiation having a wavelength of greater than 910 nm when viewed at an incidence angle of about 60 degrees or less. In some embodiments, the first set of identifying information is (1) detectable when exposed to radiation having a wavelength of between about 750 nm and about 850 nm when viewed at an incidence angle of about 45 degrees or less and (2) non-interfering when exposed to radiation having a wavelength of greater than 910 nm when viewed at an incidence angle of about 45 degrees or less.

In some embodiments, the first set of identifying information is (1) detectable when exposed to radiation having a wavelength of between about 750 nm and about 850 nm when viewed at an incidence angle of about 30 degrees or less and (2) non-interfering when exposed to radiation having a wavelength of greater than 910 nm when viewed at an incidence angle of about 30 degrees or less.

Some embodiments relate to a method of reading identifying information on an optically active substrate, comprising: (a) exposing a license plate scene to radiation having a wavelength in the visible spectrum and capturing a first license plate image, the first license plate image including first license plate identifying information that is substantially visible in the visible spectrum and second license plate identifying information that is not substantially visible in the visible spectrum; (b) exposing a license plate scene to radiation having a wavelength between about 750 nm and about 850 nm and capturing a second license plate image, the second license plate image including first license plate identifying information that is detectable and second license plate identifying information that is non-interfering; and (c) exposing a license plate scene to radiation having a wavelength of greater than about 910 nm and capturing a third license plate image, the third license plate image including first license plate identifying information that is non-interfering and second license plate identifying information that is detectable. In some embodiments, the method further includes segmenting each of first, second, and third license plate images into respective first, second, and third license plate character images; and pre-processing the license plate character images to remove a local background variation and to define a local feature thereof utilizing a quantization transformation.

Some embodiments relate to a method of performing automated license plate recognition, comprising: (a) exposing a license plate scene to radiation having a wavelength in the visible spectrum and capturing a first license plate image, the first license plate image including first license plate identifying information that is substantially visible in the visible spectrum and second license plate identifying information that is not substantially visible in the visible spectrum; (b) exposing a license plate scene to radiation having a wavelength between about 750 nm and about 850 nm and capturing a second license plate image, the second license plate image including first license plate identifying information that is detectable and second license plate identifying information that is non-interfering; (c) exposing a license plate scene to radiation having a wavelength of greater than about 910 nm and capturing a third license plate image, the third license plate image including first license plate identifying information that is non-interfering and second license plate identifying information that is detectable; (d) segmenting each of the first, second, and third license plate images into respective first license plate character images, second license plate character images, and third license plate character images; and (e) pre-processing the first, second, and third license plate character images to remove a local background variation and to define a local feature thereof utilizing a quantization transformation.

Some embodiments relate to an ALPR system including (a) a first radiation source that exposes a license plate scene to radiation having a wavelength in the visible spectrum; (b) a first image capturing unit that captures a first license plate image when the license plate is exposed to radiation having a wavelength in the visible spectrum, the first license plate image including first license plate identifying information that is substantially visible in the visible spectrum and second license plate identifying information that is not substantially visible in the visible spectrum; (c) a second radiation source that exposes a license plate scene to radiation having a wavelength between about 750 nm and about 850 nm; (d) a second image capturing unit that captures a second license plate image when the license plate is exposed to radiation having a wavelength between about 750 nm and about 850 nm, the second license plate image including first license plate identifying information that is detectable and second license plate identifying information that is non-interfering; (e) a third radiation source that exposes a license plate scene to radiation having a wavelength of greater than about 910 nm; and (f) a third image capturing unit that captures third license plate image, the third license plate image including first license plate identifying information that is non-interfering and second license plate identifying information that is detectable. In some embodiments of the ALPR system, the first, second, and third radiation source is either the same device or multiple devices. In some embodiments of the ALRP system, the first, second, and third image capturing units are either the same device or multiple devices. In some embodiment, the ALPR system includes a license plate as described herein.

### BRIEF DESCRIPTION OF DRAWINGS

FIG. 1 is a reflectance chart of retroreflective sheetings prepared as described in Examples 1-5.

FIGS. 2A, 2B, and 2C, are photographs of a license plate prepared as described in Example 6 and exposed to radiation having a wavelength of, respectively, broadband visible light, 810 nm and 950 nm.

FIGS. 3A, 3B, and 3C, are photographs of a license plate prepared as described in Example 7 and exposed to radiation having a wavelength of, respectively, broadband visible light, 810 nm and 950 nm.

FIG. 4 is a reflectance chart of retroreflective sheetings prepared as described in Examples 8-11.

### DETAILED DESCRIPTION

Various embodiments and implementations will be described in detail. These embodiments should not be construed as limiting the scope of the present disclosure in any manner, and changes and modifications may be made without departing from the spirit and scope of the inventions. Further, only some end uses have been discussed herein, but end uses not specifically described herein are included within the scope of the present disclosure. As such, the scope of the present disclosure should be determined only by the claims.

As used herein, the term “infrared” refers to electromagnetic radiation with longer wavelengths than those of visible radiation, extending from the nominal red edge of the visible spectrum at around 700 nanometers (nm) to over 1000 nm. It is recognized that the infrared spectrum extends beyond this value.

As used herein, the term “visible spectrum” or “visible” refers to the portion of the electromagnetic spectrum that is visible to (can be detected by) the human eye. A typical human eye will respond to wavelengths from about 390 to 700 nm.

As used herein, the term “substantially visible” refers to the property of being discernible to most humans' naked eye when viewed at a distance of greater than 10 meters. (i.e., an observer can identify, with repeatable results, a sample with a unique marking from a group without the marking.) For purposes of clarity, “substantially visible” information can be seen by a human's naked eye when viewed either unaided and/or through a machine (e.g., by using a microscope, a camera using, or in a printed or onscreen printout of a photograph taken at any wavelength of radiation).

As used herein, the term “substantially invisible” refers to the property of being not “substantially visible,” as defined above). For purposes of clarity, substantially invisible information cannot be seen by a human's naked eye when viewed by the naked eye and/or through a machine.

As used herein, the term “detectable” refers to the ability of a machine vision system to extract a piece of information from an image through the use of standard image processing techniques such as, but not limited to, thresholding.

As used herein, the term “non-interfering” means that information will not interfere with the extraction of other information that may be within the same physical image space.

As used herein, the term “optically active” with reference to sheeting refers to sheeting that is at least one of reflective and/or retroreflective.

The term “retroreflective” as used herein refers to the attribute of reflecting an obliquely incident radiation ray in a direction generally antiparallel to its incident direction such that it returns to the radiation source or the immediate vicinity thereof.

As used herein, the term “human-readable information” refers to information and/or data that is capable of being processed and/or understood by a human with 20/20 vision without the aid or assistance of a machine or other processing device. For example, a human can process (e.g., read) alphanumerics or graphics because a human can process and understand the message or data conveyed by these types of visual information. As such, alphanumerics (e.g., written text and license place alphanumerics) and graphics are two non-limiting examples of types of information considered to be human-readable information as defined here.

As used herein, the term “machine-readable information” refers to information and/or data that cannot be processed and/or understood without the use or assistance of a machine or mechanical device. For example, even though a human can detect the visual presence of the vertical stripes that visually represent a barcode, a human cannot generally process and understand the information coded into a barcode without the use or assistance of a machine or mechanical device. As such, a barcode (e.g., 1D barcodes as used in retail stores and 2D QR barcodes) is one non-limiting example of machine-readable information as defined herein. In contrast, as described above, alphanumerics and graphics are two non-limiting examples of types of information considered not to be machine-readable information as defined herein.

As used herein, the term “set” with respect to identifying information can include one or more individual pieces or portions.

Some embodiments of the present disclosure relate to a license plate or optically active sheeting including identifying information (in some instances, human-readable information) that is (1) substantially visible when exposed to radiation having a wavelength in the visible spectrum (e.g. 390 nm to 700 nm); (2) that is detectable when exposed to radiation having a wavelength of between about 750 nm and about 850 nm; and (3) non-interfering when exposed to radiation having a wavelength of greater than about 910 nm.

In some embodiments, the identifying information is human-readable information. In some embodiments, the identifying information is an alphanumeric plate identifier. In some embodiments, the identifying information includes alphanumerics, graphics, and/or symbols. In some embodiments, the identifying information is formed from or includes at least one of an ink, a dye, a thermal transfer ribbon, a colorant, a pigment, and/or an adhesive coated film.

In some embodiments, the license plate or optically active sheeting includes identifying information (in some instances, human-readable information) that is (1) substantially visible when exposed to radiation having a wavelength of between about 450 nm and about 700 nm; (2) detectable when exposed to radiation having a wavelength of between about 790 nm and about 820 nm; and (3) non-interfering when exposed to radiation having a wavelength of about 930 nm to about 970 nm.

In some embodiments, the license plate or optically active sheeting includes identifying information (in some instances, human-readable information) that is (1) substantially visible when exposed to radiation having a wavelength of between about 450 nm and about 700 nm; (2) detectable when exposed to radiation having a wavelength of about 810 nm; and (3) non-interfering when exposed to radiation having a wavelength of about 950 nm.

In some embodiments, the identifying information is (1) detectable when exposed to radiation having a wavelength of between about 750 nm and about 850 nm when viewed at an incidence angle of about 60 degrees or less (or 50 degrees or less, or 45 degrees or less, or 40 degrees or less, or 30 degrees or less, or 15 degrees or less) and (2) non-interfering when exposed to radiation having a wavelength of greater than 910 nm when viewed at an incidence angle of about 60 degrees or less (or 50 degrees or less, or 45 degrees or less, or 40 degrees or less, or 30 degrees or less, or 15 degrees or less). In some embodiments, the identifying information is (1) detectable when exposed to radiation having a wavelength of between about 750 nm and about 850 nm when viewed at an incidence angle of about 45 degrees or less and (2) non-interfering when exposed to radiation having a wavelength of greater than 910 nm when viewed at an incidence angle of about 45 degrees or less. In some embodiments, the identifying information is (1) detectable when exposed to radiation having a wavelength of between about 750 nm and about 850 nm when viewed at an incidence angle of about 30 degrees or less and (2) non-interfering when exposed to radiation having a wavelength of greater than 910 nm when viewed at an incidence angle of about 30 degrees or less.

In some embodiments, the license plate or optically active sheeting additionally includes a second (or additional) set of identifying information (in some instances, machine-readable information) that is (1) substantially invisible when exposed to radiation in the visible spectrum (e.g. 390 nm to 700 nm); (2) non-interfering when exposed to radiation having a wavelength of between about 750 nm and about 850 nm; and (3) detectable when exposed to radiation having a wavelength of greater than about 910 nm.

In some embodiments, the second (or additional) set of identifying information includes at least one of a bar code, alphanumerics, graphics, symbols, and/or adhesive-coated film. In some embodiments, the second (or additional) set of identifying information is formed from or includes multi-layer optical film, a material including an optically active pigment or dye, or an optically active pigment or dye.

In some embodiments, the second (or additional) set of identifying information is (1) substantially invisible when exposed to radiation having a wavelength of between about 450 nm and about 700 nm; (2) non-interfering when exposed to radiation having a wavelength of between about 790 nm and about 820 nm; and (3) detectable when exposed to radiation having a wavelength of between about 930 nm and about 970 nm.

In some embodiments, the optically active sheeting is one of reflective or retroreflective. The retroreflective sheeting can be either microsphere-based sheeting (often referred to as beaded sheeting) or cube corner sheeting (often referred to as prismatic sheeting). Illustrative examples of microsphere-based sheeting are described in, for example, U.S. Pat. No. 3,190,178 (McKenzie), U.S. Pat. No. 4,025,159 (McGrath), and U.S. Pat. No. 5,066,098 (Kult). Illustrative examples of cube corner sheeting are described in, for example, U.S. Pat. No. 1,591,572 (Stimson), U.S. Pat. No. 4,588,258 (Hoopman), U.S. Pat. No. 4,775,219 (Appledorn et al.), U.S. Pat. No. 5,138,488 (Szczech), and U.S. Pat. No. 5,557,836 (Smith et al.). A seal layer may be applied to the structured cube corner sheeting surface to keep contaminants away from individual cube corners. Flexible cube corner sheetings, such as those described, for example, in U.S. Pat. No. 5,450,235 (Smith et al.) can also be incorporated in embodiments or implementations of the present disclosure. Retroreflective sheeting for use in connection with the present disclosure can be, for example, either matte or glossy.

Some embodiments of the present disclosure relate to retroreflective sheeting having (1) a first set of identifying information that is (1) visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less; and (2) a second set of identifying information that is (1) invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less.

In some embodiments, the retroreflective sheeting includes a first set of identifying information that is (1) visible when exposed to radiation having a wavelength of between about 450 nm and about 700 nm at an incidence angle of 30 degrees or less; (2) detectable when exposed to radiation having a wavelength of between about 790 nm and about 820 nm at an incidence angle of 30 degrees or less; and (3) non-interfering when exposed to radiation having a wavelength of about 930 nm to about 970 nm an incidence angle of 30 degrees or less. In some embodiments, the retroreflective sheeting includes a second set of identifying information that is (1) invisible when exposed to radiation having a wavelength of between about 450 nm and about 700 nm at an incidence angle of 30 degrees or less; (2) undetectable when exposed to radiation having a wavelength of between about 790 nm and about 820 nm at an incidence angle of 30 degrees or less; and (3) detectable when exposed to radiation having a wavelength of between about 930 nm and about 970 nm at an incidence angle of 30 degrees or less.

The optically active or retroreflective sheeting can be used for, for example, as signage. The term “signage” as used herein refers to an article that conveys information, usually by means of alphanumeric characters, symbols, graphics, or other indicia. Specific signage examples include, but are not limited to, signage used for traffic control purposes, street signs, identification materials (e.g., licenses), and vehicle license plates.

Some embodiments of the present disclosure relate to a kit for making a license plate, comprising: (1) optically active sheeting; (2) identifying information on the optically active sheeting, the identifying information being (1) invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less; and (3) a material meant for application to the optically active sheeting that is (1) visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less. In some embodiments, the kit also includes instructions for applying the material to the optically active sheeting. In some embodiments, the kit includes the optically active sheeting described herein.

Some embodiments of the present disclosure relate to a kit for making a license plate, comprising: (1) optically active sheeting; (2) identifying information on the optically active sheeting, the identifying information being (1) invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less; and (3) instructions for applying a material to the optically active sheeting, the material being (1) visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less. In some embodiments, the kit includes the optically active sheeting described herein.

In some embodiments, the kit includes an application device for applying the material onto the optically active sheeting. Exemplary application devices include printing systems, roll coating systems, etc. Exemplary printing systems include, for example, digital printing systems, thermal transfer printing systems, inkjet printing systems, and presses.

Some embodiments of the present disclosure relate to methods of making a license plate. In some embodiments, the license plate has at least one of the features described herein. In some embodiments, the license plate includes the optically active sheeting described herein. In some embodiments, the method involves using the kit described herein according to the instructions. In some embodiments, the method involves (A) forming a first set of identifying information on optically active sheeting, the first set of identifying information formed by or including a first material that is (1) substantially visible when exposed to radiation having a wavelength that is between about 390 nm and about 700 nm; (2) detectable when exposed to radiation having a wavelength of between about 750 nm and about 850 nm; and (3) non-interfering when exposed to radiation having a wavelength of greater than 910 nm; and (B) forming a second set of identifying information on optically active sheeting, the second set of identifying information formed by or including a second material that is (1) substantially invisible when exposed to radiation having a wavelength of between about 390 nm and about 700 nm; (2) non-interfering when exposed to radiation having a wavelength of between about 750 nm and about 850 nm; and (3) detectable when exposed to radiation having a wavelength of greater than 910 nm.

Exemplary license plate detection or license plate recognition systems or methods of reading identifying information on an optically active substrate use a camera and a radiationing system to capture license plate images. An image of the license plate scene including the license plate can be made from ambient radiation and from radiation added by a designated radiation source (for example, coaxial radiationing that directs radiation rays onto the license plate when the camera is preparing to record an image). The radiation rays emitted by the coaxial radiationing in combination with the reflective or retroreflective properties of the license plate create a strong, bright signal from the location of the license plate in the otherwise large image scene. The bright signal is used to identify the location of the license plate. Then, the automatic license plate recognition (ALPR) focuses on the region of interest (the region of brightness) and searches for matches to expected indicia or identifying information by looking for recognizable patterns of contrast. The recognized indicia or identifying information are often provided with some assessment of the confidence in the match to another computer or other communication device for dispatching the information about the observed license plate.

The radiation detected by the camera can come from any of a number of sources. Of particular interest is the radiation reflected from the license plate and the amount of radiation reflected from each area inside that region of interest on the license plate. The camera or detection system collects radiation from each region of the license plate with the goal of creating a difference (contrast) between each indicia or piece of identifying information on the license plate. Contrast can be effected in numerous ways, including the use of coaxial radiationing to overwhelm the amount of radiation coming from ambient radiation sources. The use of filters on the camera can help accentuate the differences between the indicia or identifying information and background by selectively removing undesired portions of the radiation spectrum and passing only the desired portions of the radiation spectrum.

The radiation in the driving and ALPR environment can be divided into the following spectral regions: visible radiation and infrared radiation. Typical cameras have sensitivity that includes both of these ranges, although the sensitivity of a standard camera system decreases significantly for wavelengths longer than 1100 nm. Various radiation (or light) emitting diodes (LEDs) can emit radiation over this entire wavelength range, and typically most LEDs are characterized by a central wavelength and a narrow distribution around that wavelength.

The cameras and radiations for these systems are typically mounted to view the license plates at some angle to the direction of vehicle motion. Exemplary mounting locations include positions above the traffic flow or from the side of the roadway. Images are typically collected at an incidence angle of between about 10 degrees to about 60 degrees from normal incidence (head-on) to the license plate. In some embodiments, the images are collected at an incidence angle of between about 20 degrees to about 45 degrees from normal incidence (head-on) to the license plate. Some exemplary preferred angles include, for example, 30 degrees, 40 degrees, and 45 degrees.

A detector which is sensitive to infrared or ultraviolet radiation as appropriate would be used to detect retroreflected radiation outside of the visible spectrum. Exemplary commercially available cameras include but are not limited to the P372, P382, and P492 cameras sold by 3M Company.

Some embodiments of the present disclosure relate to reading identifying information that is on an optically active substrate. In some embodiments, the identifying information is on the license plate or optically active sheeting described herein. In some embodiments, the method involves (1) exposing a license plate scene to radiation having a wavelength in the visible spectrum and capturing a first license plate image, the first license plate image including first license plate identifying information that is substantially visible in the visible spectrum and second license plate identifying information that is not substantially visible in the visible spectrum; (2) exposing a license plate scene to radiation having a wavelength between about 750 nm and about 850 nm and capturing a second license plate image, the second license plate image including first license plate identifying information that is detectable and second license plate identifying information that is non-interfering; and (3) exposing a license plate scene to radiation having a wavelength of greater than about 910 nm and capturing a third license plate image, the third license plate image including first license plate identifying information that is non-interfering and second license plate identifying information that is detectable. In some embodiments, the method or process further involves segmenting each of first, second, and third license plate images into respective first, second, and third license plate character images; and pre-processing the license plate character images to remove a local background variation and to define a local feature thereof utilizing a quantization transformation.

Some embodiments of the present disclosure relate to a method of performing automated license plate recognition. In some embodiments, the method includes the license plate or optically active sheeting described herein. In some embodiments, the method involves (1) exposing a license plate scene to radiation having a wavelength in the visible spectrum and capturing a first license plate image, the first license plate image including first license plate identifying information that is substantially visible in the visible spectrum and second license plate identifying information that is not substantially visible in the visible spectrum; (2) exposing a license plate scene to radiation having a wavelength between about 750 nm and about 850 nm and capturing a second license plate image, the second license plate image including first license plate identifying information that is detectable and second license plate identifying information that is non-interfering; (3) exposing a license plate scene to radiation having a wavelength of greater than about 910 nm and capturing a third license plate image, the third license plate image including first license plate identifying information that is non-interfering and second license plate identifying information that is detectable; (4) segmenting each of the first, second, and third license plate images into respective first license plate character images, second license plate character images, and third license plate character images; and (5) pre-processing the first, second, and third license plate character images to remove a local background variation and to define a local feature thereof utilizing a quantization transformation.

Some embodiments of the present disclosure relate to an ALPR system. In some embodiments, the ALPR system includes the license plate or optically active sheeting described herein. In some embodiments, the ALPR system includes (1) a first radiation source that exposes a license plate scene to radiation having a wavelength in the visible spectrum; (2) a first image capturing unit that captures a first license plate image when the license plate is exposed to radiation having a wavelength in the visible spectrum, the first license plate image including first license plate identifying information that is substantially visible in the visible spectrum and second license plate identifying information that is not substantially visible in the visible spectrum; (3) a second radiation source that exposes a license plate scene to radiation having a wavelength between about 750 nm and about 850 nm; (4) a second image capturing unit that captures a second license plate image when the license plate is exposed to radiation having a wavelength between about 750 nm and about 850 nm, the second license plate image including first license plate identifying information that is detectable and second license plate identifying information that is non-interfering; (5) a third radiation source that exposes a license plate scene to radiation having a wavelength of greater than about 910 nm; (6) a third image capturing unit that captures third license plate image, the third license plate image including first license plate identifying information that is non-interfering and second license plate identifying information that is detectable. In some of these embodiments, the first, second, and third radiation source are a single radiation source. In some embodiments, the first, second, and third radiation sources are two or more radiation sources. In some embodiments, the first, second, and third imagine capturing units are a single device. In some embodiments, the first, second, and third image capturing units are two or more devices.

In some embodiments, near-infrared absorbing dyes and pigments are useful for any of the embodiments described in the present disclosure. Some exemplary classes or families of such near-infrared absorbing dyes and pigments include, for example, phthalocyanines, naphthalocyanines, perylene imides, cyanines, squarililiums, and transition metal dithiolenes. Exemplary commercially available near-infrared absorbing dyes and pigments include those sold by, for example, Epolin Inc (Newark, N.J.), Nippon Shokubai (Osaka, Japan), FujiFilm Company (New Castle, Del.), QCR Solutions Inc. (Port St. Lucie, Fla.), and HW Sands (Jupiter, Fla.). One skilled in the art may also be able to choose from a variety of dye families based on their absorbance properties. Inks may be formulated in different ink vehicles which are water, solvent, or UV-curable.

In some embodiments, phthalocyanine pigments and/or dyes are useful in the embodiments of the present disclosure. Within the phthalocyanines family, amino- and thio-substituted phthalocyanines are two classes of dyes suitable for use in the embodiments of the present disclosure. Several IR Dyes based on phthalocyanine from Nippon Shokubai are useful in the embodiments of the present disclosure.

Also, halogenated phthalocyanines are useful in the embodiments of the present disclosure. Commercially available halogenated phthalocyanines include, for example, Pigment Green 7 and Pigment Green 36, both of which are useful in the embodiments of the present disclosure. Pigment Green 7 is chlorinated-copper phthalocyanine. Pigment Green 7 (chloro copper phthalocyanine) is commercially available from, for example, BASF (Florham Park, N.J.), under trade name Microlith™ Green 8750T and Sunfast™ Green 7 from Sun Chemicals (Parsippany, N.J.). Aurasperse™ W6013 Phthalo Green is a water based ink containing Pigment Green 7 (chlorinated copper phthalocyanine) available from BASF. Other inks useful in the present application include those containing Pigment Green 7 in other solvent or as UV-curable ink vehicles for example, 3M™ Screen Printing Ink 1914 Dark Green (solvent based screen printing ink), 3M™ Screen Printing UV Ink Series 9864 Transparent Green (BS) (UV curable screen printing ink), and UV Flexo FR Green (available from Sun Chemicals).

Pigment Green 36 is mixed chloro, bromo copper phthalocyanine. Pigment Green 36 is available under different trade names including, for example, Heliogen™ Green K 9360 from BASF, Sunfast™ Green 36 from Sun Chemicals, and 3M™ Screen Printing UV Ink Series 9861 Light Green (UV curable screen printing ink containing Pigment Green 36 as colorant).

Perylene pigments are also useful in the embodiments of the present disclosure. Some commercially available perylene pigments include, for example, Lumogen™ Black FK4280, Lumogen™ IR 765, and Lumogen™ IR 788, all available from BASF.

The articles, including optically active sheeting and license plates, described herein can be used to improve the capture efficiency of these license plate detection or recognition systems. Capture efficiency can be described as the process of correctly locating and identifying license plate data, including, but not limited to, indicia, plate type, and plate origin. Applications for these automated systems include, but are not limited to, electronic toll systems, red radiation running systems, speed enforcement systems, vehicle tracking systems, trip timing systems, automated identification and alerting systems, and vehicle access control systems. As is mentioned above, current automatic license plate recognition systems have capture efficiencies that are lower than desired due to, for example, low or inconsistent contrast of identifying information as well as obscuring (because of, for example, overlapping) identifying information on the license plate.

Objects and advantages of the present disclosure are further illustrated by the following examples, but the particular materials and amounts thereof recited in the examples, as well as other conditions and details, should not be construed to unduly limit the scope of the application, as those of skill in the art will recognize that other parameters, materials, and equipment may be used. All parts, percentages and ratios herein are by weight unless otherwise specified.

### EXAMPLES

Test Methods

Reflectance:

Reflectance of Examples 1 through 5 was measured using a spectrophotometer (model 10500, obtained from Perkin Elmer Lambda) fitted with a PELA-1002 integrating sphere accessory. The sphere was 150 mm (6 inches) in diameter and complied with ASTM methods E903, D1003, E308, et. al. as published in “ASTM Standards on Color and Appearance Measurements”, Third Edition, ASTM, 1991. All other samples were analyzed for percent reflectance with a white background plate behind the sample. The spectra was measured in the range 250-2500 nm. The slit width and data interval were 5 nm.

Materials

| Trade Designation | Description | Supplier |
|---|---|---|
| AURASPERSE W6013 | Colorant that can be used for water- | BASF Corp. North |
| | based and emulsion systems | America, NJ, USA |
| INCOREZ W835/140 | Polyurethane dispersion | Incorez Ltd, UK |
| 3M REFLECTIVE LICENSE | Beaded retroreflective sheeting | 3M Company |
| PLATE SHEETING SERIES 3750 | | |
| 3M DIGITAL LICENSE PLATE | Beaded retroreflective sheeting | 3M Company |
| SHEETING 9250 | | |
| TTR1304 CYAN 100%, | Thermal transfer ribbons | 3M Company |
| TTR1305 MAGENTA 100%, | Thermal transfer ribbons | 3M Company |
| TTR1306 YELLOW 100% | Thermal transfer ribbons | 3M Company |
| TTR1312 SPOT GREEN 90% | Thermal transfer ribbons | 3M Company |
| SR238B | 1,6-hexanediol diacrylate ester | Sartomer, USA |
| | (HDDA). Difunctional acrylic monomer | |

### Examples 1-5

Retroreflective sheetings including coatings that were substantially visible when exposed to visible light, detectable when exposed to radiation having a wavelength of between about 750-850 nm, and non-interfering when exposed to radiation having a wavelength of greater than 910 nm were prepared.

Pigment dispersions were prepared by mixing AURASPERSE W6013 and INCOREZ W835/140 in a glass vial. The amount of each component is listed in Table 1, below. The resulting mixture was stirred at room temperature using a vortex mixer for about 2 minutes.

TABLE 1
Component Amounts

| | AURASPERSE | |
|---|---|---|
| Pigment dispersions | W6013 (g) | INCOREZ W835/140 (g) |
| Pigment Dispersion 1 | 1 | 1 |
| Pigment Dispersion 2 | 1 | 2 |
| Pigment Dispersion 3 | 1 | 3 |
| Pigment Dispersion 4 | 0.5 | 2.5 |
| Pigment Dispersion 5 | 0.5 | 3.5 |

Pigment dispersions 1-5 were then coated on the beaded retroreflective sheeting (3M REFLECTIVE LICENSE PLATE SHEETING SERIES 3750) using a Meyer Rod No. 7. The coatings were dried in an oven at 75° C. for about 10 minutes under flowing nitrogen to form Examples 1-5.

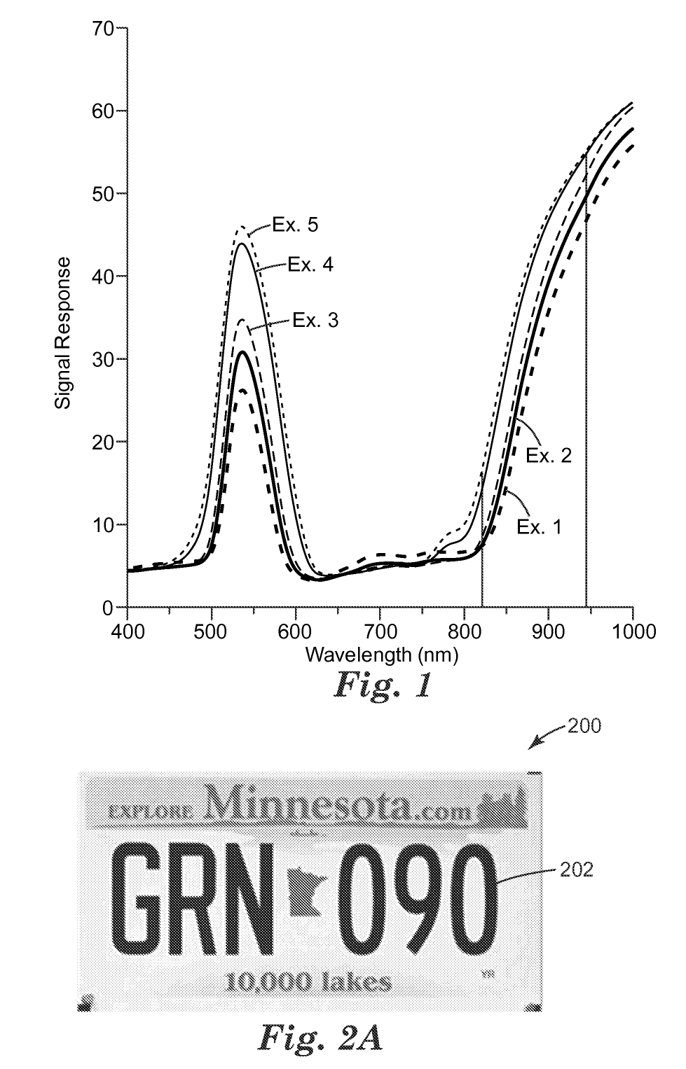

Reflectance for Examples 1-5 was measured using the procedure described above. Results were plotted in a chart and are shown in FIG. 1

### Example 6

A retroreflective sheeting including identifying information substantially that was visible when exposed to visible light, detectable when exposed to radiation having a wavelength of between about 750-850 nm, and non-interfering when exposed to radiation having a wavelength of greater than 910 nm was prepared.

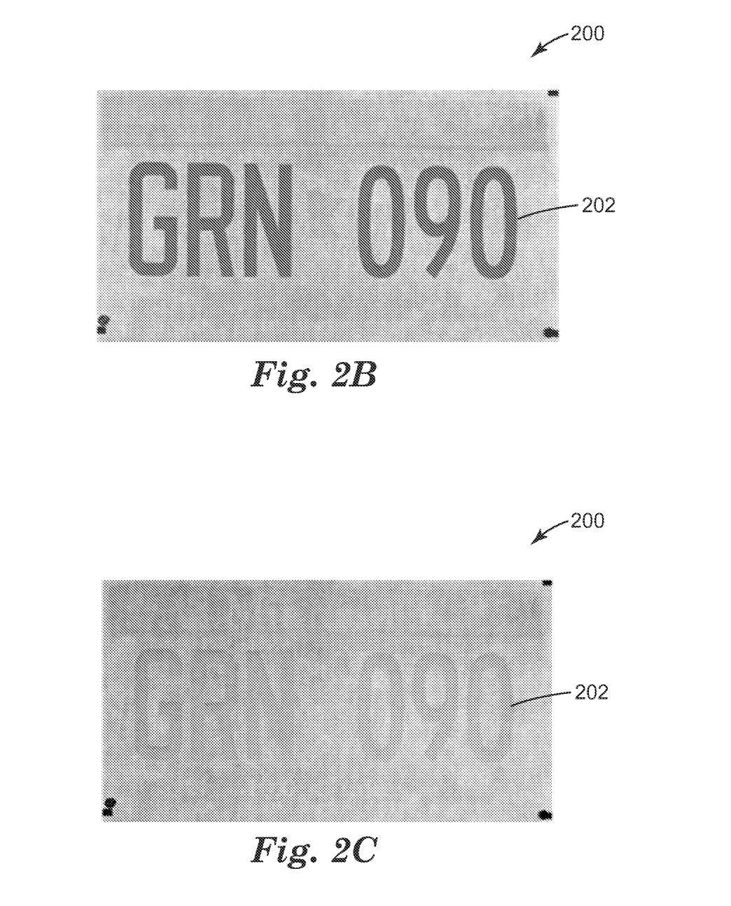

FIG. 2A is a photograph of a Minnesota license plate 200 taken in diffuse (scattered) visible light using a digital camera (model D700 from Nikon). The camera was disassembled, the IR block filter removed and in its place infrared transmitting/passing filters (obtained under the trade designation “HOYA”, from Kenko Tokina USA, Inc, CA) were placed in front of the lens and narrow spectrum LED emitters were arranged in a configuration known as ring light.

License plate 200 included identifying information 202 comprising “GRN 090” alphanumeric characters. The identifying information was printed on a retroreflective sheeting 204 (3M DIGITAL LICENSE PLATE SHEETING 9250) using a DIGITAL LICENSE PLATE (DLP) THERMAL RIBBON LICENSE PLATE PRINTER (obtained from 3M Company) using the following thermal transfer ribbons: TTR1304 CYAN 100%, TTR1305 MAGENTA 100%, TTR1306 YELLOW 100% AND TTR1312 SPOT GREEN 90%. As shown in FIG. 2 A, identifying information 202 was visible to the human eye in diffuse visible light.

FIG. 2B is a photograph of license plate 200 taken under retroreflective near-infrared conditions, specifically, at a wavelength of 810 nm. As it may be seen, identifying information 202 is detectable in these conditions.

FIG. 2C is a photograph of license plate 200 taken under retroreflective near-infrared conditions, specifically, at a wavelength of 950 nm. As it may be seen, identifying information 202 is non-interfering in these conditions.

### Example 7

A retroreflective sheeting including: (a) identifying information substantially that was visible when exposed to visible light, detectable when exposed to radiation having a wavelength of between about 750-850 nm, and non-interfering when exposed to radiation having a wavelength of greater than 910 nm; and (b) additional identifying information that was substantially invisible when exposed to radiation having a wavelength of between about 390 nm and about 700 nm, non-interfering when exposed to radiation having a wavelength of between about 750 nm and about 850 nm, and detectable when exposed to radiation having a wavelength of greater than 910 nm, was prepared.

License plate 300 was prepared as described in Example 6, except that additional identifying information 302 was provided. The additional identifying information comprised a bar code 304 prepared using a multilayer optical film (MOF) commercially available under the trade designation “Prestige Window Film”, from 3M Company, except that the film comprised 120 layers and had a total thickness of about 1 mil. The MOF was laminated over the printed retroreflective sheeting.

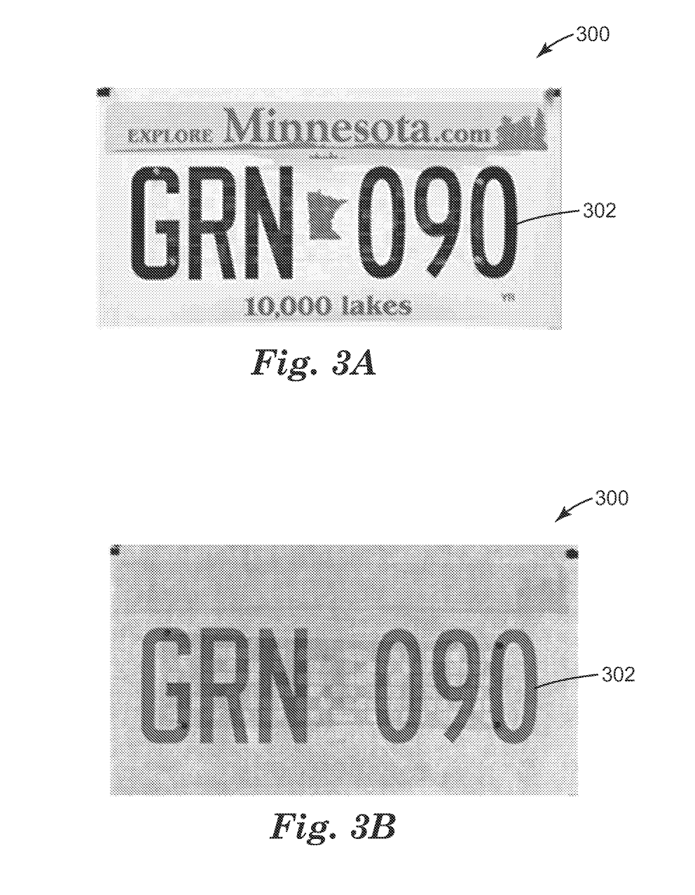

FIG. 3A is a photograph of license plate 300 taken under diffuse visible light. As it may be seen, identifying information 302 was visible to the human eye, and the additional identifying information 304 was substantially invisible in these conditions.

FIG. 3B is a photograph of license plate 300 taken under retroreflective near-infrared conditions, specifically, at a wavelength of 810 nm. As it may be seen, identifying information 302 is detectable in these conditions and additional identifying information 304 is non-interfering.

FIG. 3C is a photograph of license plate 300 taken under retroreflective near-infrared conditions, specifically, at a wavelength of 950 nm. As it may be seen, identifying information 302 is non-interfering in these conditions, but additional identifying information 304 is detectable in these conditions.

The contrast of a digital image is the grey value of the appropriately selected light areas in a ratio to the grey value of the appropriately selected dark areas. The contrast of an object is theoretically the same as the contrast of an image of that object. However the lighting conditions need to be specified and the exposure needs to be carefully controlled. The light areas must not saturate the detector and the dark areas must be sufficiently above the noise level that the noise does not substantially affect the measurement. For these reasons, it is difficult (sometimes impossible) to measure the contrast of high contrast objects from a single image. An 8 bit camera can theoretically measure a contrast of up to 256:1.

Analyzing the grey values in FIGS. 3A-3C, the contrast for the indicia at detected at 400-700 nm, 810 nm, and 950 nm was, respectively, 20/1, 2.5/1 and 1.1/1. The contrast for the barcode at the same wavelengths, was, respectively, 1/1, 1.2/1 and 10/1.

### Examples 8-9

A coating composition was prepared by mixing 2 g of 3M SCREEN PRINTING UV INK SERIES 9861 LIGHT GREEN with 2 g of SR238B (1,6-Hexanediol Diacrylate) in a glass vial. The resulting mixture was stirred at room temperature using a vortex mixer for 2 min.

Coated retroreflective sheetings were prepared using the coating composition and varying Meyer Rods, as shown in Table 2, below. The compositions were dried in an oven at 75° C. for 5 minutes under flowing nitrogen and subsequently UV cured by passing the coated retroreflective sheetings through a UV processor fitted with an H-bulb (obtained from Fusion System Inc.) three times at 40 feet per minute.

### Examples 10-11

Coated retroreflective sheetings were prepared as described in Examples 8-9, except that the coating composition comprised 2 g of 3M SCREEN PRINTING UV INK SERIES 9864 TRANSPARENT GREEN mixed with 2 g of SR238B (1,6-Hexanediol Diacrylate) in a glass vial.

TABLE 2
Meyer Rod No. for Examples 8-11.

| Examples | Meyer Rod No. |
|---|---|
| Example 8 | 7 |
| Example 9 | 12 |
| Example 10 | 7 |
| Example 11 | 12 |

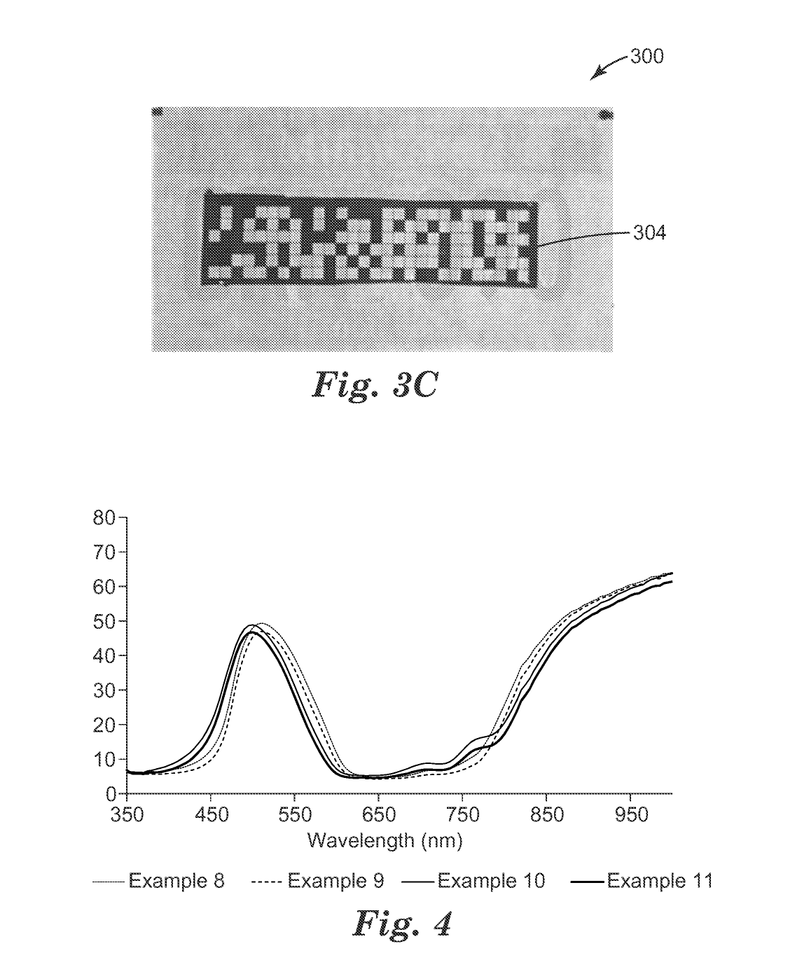

Reflectance for Examples 8-11 was measured using the procedure described above. Results were plotted in a chart, shown in FIG. 4.

Those having skill in the art will appreciate that many changes may be made to the details of the above-described embodiments and implementations without departing from the underlying principles thereof. The scope of the present disclosure should, therefore, be determined only by the following claims.

1. A license plate, comprising:
identifying information that is
(1) substantially visible when exposed to radiation having a wavelength that is between about 390 nm and about 700 nm;
(2) detectable when exposed to radiation having a wavelength of between about 750 nm and about 850 nm; and
(3) non-interfering when exposed to radiation having a wavelength of greater than 910 nm.

2. The license plate of claim 1, wherein the identifying information is
(1) substantially visible when exposed to radiation having a wavelength of between about 450 nm and about 700 nm;
(2) detectable when exposed to radiation having a wavelength of between about 790 nm and about 820 nm; and
(3) non-interfering when exposed to radiation having a wavelength of about 930 nm to about 970 nm.

3. The license plate of claim 1, further comprising:
additional identifying information that is
(1) substantially invisible when exposed to radiation having a wavelength of between about 390 nm and about 700 nm;
(2) non-interfering when exposed to radiation having a wavelength of between about 750 nm and about 850 nm; and
(3) detectable when exposed to radiation having a wavelength of greater than 910 nm.

4. The license plate of claim 3, where in the additional identifying information is
(1) substantially invisible when exposed to radiation having a wavelength of between about 450 nm and about 700 nm;
(2) non-interfering when exposed to radiation having a wavelength of between about 790 nm and about 820 nm; and
(3) detectable when exposed to radiation having a wavelength of between about 930 nm and about 970 nm.

5. The license plate of claim 1, wherein at least a portion of the license plate is reflective or retroreflective.

6. The license plate of claim 3, wherein the identifying information includes at least one of alphanumerics, graphics, symbols, and/or the additional identifying information includes at least one of a bar code, alphanumerics, graphics, and symbols.

7. The license plate of claim 1, wherein the identifying information includes at least one of an ink, a dye, a thermal transfer ribbon, a colorant, a pigment, and a transferfilm.

8. The license plate of claim 3, wherein the additional identifying information includes at least one of multi-layer optical film, a material including an optically active pigment or dye, or an optically active pigment or dye.

9. The license plate of claim 1, wherein the identifying information is human-readable.

10. The license plate of claim 3, wherein the additional identifying information is machine-readable.

11-13. (canceled)

14. Retroreflective sheeting, comprising:
a first set of identifying information that is (1) visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less; and
a second set of identifying information that is (1) invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less.

15. The retroreflective sheeting of claim 14, wherein the first set of identifying information is (1) visible when exposed to radiation having a wavelength of between about 450 nm and about 700 nm at an incidence angle of 30 degrees or less; (2) detectable when exposed to radiation having a wavelength of between about 790 nm and about 820 nm at an incidence angle of 30 degrees or less; and (3) non-interfering when exposed to radiation having a wavelength of about 930 nm to about 970 nm an incidence angle of 30 degrees or less.

16. The retroreflective sheeting of claim 15, wherein the second set of identifying information is (1) invisible when exposed to radiation having a wavelength of between about 450 nm and about 700 nm at an incidence angle of 30 degrees or less; (2) undetectable when exposed to radiation having a wavelength of between about 790 nm and about 820 nm at an incidence angle of 30 degrees or less; and (3) detectable when exposed to radiation having a wavelength of between about 930 nm and about 970 nm at an incidence angle of 30 degrees or less.

17-21. (canceled)

22. A kit for making a license plate, comprising:
optically active sheeting;
identifying information on the optically active sheeting, the identifying information being (1) substantially invisible when exposed to radiation having a wavelength of between about 390 nm and about 700 nm at an incidence angle of 60 degrees or less; (2) undetectable when exposed to radiation having a wavelength of between about 750 nm and about 850 nm at an incidence angle of 60 degrees or less; and (3) detectable when exposed to radiation having a wavelength of greater than 910 nm at an incidence angle of 60 degrees or less; and
a material meant for application to the optically active sheeting that is (1) substantially visible when exposed to radiation having a wavelength of between about 390 nm and about 700 nm at an incidence angle of 60 degrees or less; (2) detectable when exposed to radiation having a wavelength of between about 750 nm and about 850 nm at an incidence angle of 60 degrees or less; and (3) non-interfering when exposed to radiation having a wavelength of greater than 910 nm at an incidence angle of 60 degrees or less.

23. (canceled)

24. A kit for making a license plate, comprising:
optically active sheeting;
identifying information on the optically active sheeting, the identifying information being (1) substantially invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less; and
instructions for applying a material to the optically active sheeting, the material being (1) substantially visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less.

25. A kit for making a license plate, comprising:
optically active sheeting;
identifying information on the optically active sheeting, the identifying information being (1) substantially invisible when exposed to radiation having a wavelength of between about 390 nm and about 700 nm at an incidence angle of 30 degrees or less; (2) undetectable when exposed to radiation having a wavelength of between about 750 nm and about 850 nm at an incidence angle of 30 degrees or less; and (3) detectable when exposed to radiation having a wavelength of greater than 910 nm at an incidence angle of 30 degrees or less; and
a material meant for application to the optically active sheeting that is (1) substantially visible when exposed to radiation having a wavelength of between about 390 nm and about 700 nm at an incidence angle of 30 degrees or less; (2) detectable when exposed to radiation having a wavelength of between about 750 nm and about 850 nm at an incidence angle of 30 degrees or less; and (3) non-interfering when exposed to radiation having a wavelength of greater than 910 nm at an incidence angle of 30 degrees or less.

26. (canceled)

27. A method of making a license plate, comprising:
forming a first set of identifying information on optically active sheeting, the first set of identifying information formed by or including a first material that is (1) substantially visible when exposed to radiation having a wavelength that is between about 390 nm and about 700 nm; (2) detectable when exposed to radiation having a wavelength of between about 750 nm and about 850 nm; and (3) non-interfering when exposed to radiation having a wavelength of greater than 910 nm; and
forming a second set of identifying information on optically active sheeting, the second set of identifying information formed by or including a second material that is (1) substantially invisible when exposed to radiation having a wavelength of between about 390 nm and about 700 nm; (2) non-interfering when exposed to radiation having a wavelength of between about 750 nm and about 850 nm; and (3) detectable when exposed to radiation having a wavelength of greater than 910 nm.

28-38. (canceled)

39. A method of reading identifying information on an optically active substrate, comprising:
exposing a license plate scene to radiation having a wavelength in the visible spectrum and capturing a first license plate image, the first license plate image including first license plate identifying information that is substantially visible in the visible spectrum and second license plate identifying information that is not substantially visible in the visible spectrum;
exposing a license plate scene to radiation having a wavelength between about 750 nm and about 850 nm and capturing a second license plate image, the second license plate image including first license plate identifying information that is detectable and second license plate identifying information that is non-interfering; and
exposing a license plate scene to radiation having a wavelength of greater than about 910 nm and capturing a third license plate image, the third license plate image including first license plate identifying information that is non-interfering and second license plate identifying information that is detectable.

40. (canceled)

41. A method of performing automated license plate recognition, comprising:
exposing a license plate scene to radiation having a wavelength in the visible spectrum and capturing a first license plate image, the first license plate image including first license plate identifying information that is substantially visible in the visible spectrum and second license plate identifying information that is not substantially visible in the visible spectrum;
exposing a license plate scene to radiation having a wavelength between about 750 nm and about 850 nm and capturing a second license plate image, the second license plate image including first license plate identifying information that is detectable and second license plate identifying information that is non-interfering;
exposing a license plate scene to radiation having a wavelength of greater than about 910 nm and capturing a third license plate image, the third license plate image including first license plate identifying information that is non-interfering and second license plate identifying information that is detectable;
segmenting each of the first, second, and third license plate images into respective first license plate character images, second license plate character images, and third license plate character images; and
pre-processing the first, second, and third license plate character images to remove a local background variation and to define a local feature thereof utilizing a quantization transformation.

42. An ALPR system, comprising:
a first radiation source that exposes a license plate scene to radiation having a wavelength in the visible spectrum;
a first image capturing unit that captures a first license plate image when the license plate is exposed to radiation having a wavelength in the visible spectrum, the first license plate image including first license plate identifying information that is substantially visible in the visible spectrum and second license plate identifying information that is not substantially visible in the visible spectrum;
a second radiation source that exposes a license plate scene to radiation having a wavelength between about 750 nm and about 850 nm;
a second image capturing unit that captures a second license plate image when the license plate is exposed to radiation having a wavelength between about 750 nm and about 850 nm, the second license plate image including first license plate identifying information that is detectable and second license plate identifying information that is non-interfering;
a third radiation source that exposes a license plate scene to radiation having a wavelength of greater than about 910 nm;
a third image capturing unit that captures third license plate image, the third license plate image including first license plate identifying information that is non-interfering and second license plate identifying information that is detectable.

43-45. (canceled)
